(19) United States
(12) Patent Application Publication
(10) Pub. No.: US 2009/0210082 A1
(43) Pub. Date: Aug. 20, 2009

(54) COMPOSITE MATERIAL FOR USE IN FORMING A PRODUCT FIXTURE ASSEMBLY FOR REDUCED WEIGHT, IMPROVED SAFETY, AND EASE OF MANUFACTURE

(75) Inventors: Russell Lewis Tartock, Springfield, IL (US); Tony Wilson, Springfield, IL (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/032,743

(22) Filed: Feb. 18, 2008

(51) Int. Cl. G06F 17/50; E01F 9/04; G06F 19/00

(52) U.S. Cl. 700/106; 700/110; 362/153.1

(57) ABSTRACT

A method and apparatus thereof for providing a material for use in forming a product fixture assembly. One or more flaws of a currently utilized material can be analyzed for use in meeting a particular requirement of a product fixture assembly in order to identify one or more alternate materials for use in meeting the particular requirement of the product fixture assembly. The alternate material(s) are then analyzed with regard to all requirements of the product fixture assembly, in response to identifying the alternate material(s). An offering of the alternate material(s) can be developed that meets the particular requirement of the product fixture assembly and overcomes the flaws(s) associated with the currently utilized material. The alternate material(s) can be then selected in order to develop the product fixture assembly. A new material may also be developed, which meets the particular requirement of the product fixture assembly.

### TECHNICAL FIELD

Embodiments are generally related to product fixture assemblies and materials for use informing such devices. Embodiments also relate to composite materials and in particular to non-conducting and electrical insulated components formed from such composite materials. Embodiments also relate to airport lighting fixtures and structures and materials for forming and maintaining such lighting fixtures.

### BACKGROUND OF THE INVENTION

Present day airports, of whatever size, make use of numerous, often hundreds, of light fixtures for purposes of illumination of the approach to, center line of, and edge of the airport runway, taxiway and parking areas to thereby minimize the possibility that an aircraft will inadvertently travel off the edge thereof. Such airport light fixtures involve considerable cost, both by way of initial capital investment, accidental breakage and maintenance in that the state-of-the-art runway light fixture is designed to withstand intense vibration and high wind velocity encountered in take-off and landing operations of jet aircraft, as well as bad weather. Such fixtures must, as well, remain operable over a broad range of environmental factors including heat, humidity, erosion, corrosion, dust, wind, vegetation and insects. Accordingly, each runway light fixture represents a significant, but risk prone, capital asset of the airport.

Current Airport lighting fixtures are generally produced from Aluminum or Steel. These are usually heavy, cumbersome parts to handle by maintenance personnel. Additionally, these parts are electrically conductive. In the event of a ground fault condition, a worker can receive a shock while working on the lamp in the field. Due to the nature of metal production methods, the assemblies are expensive to manufacture. The weight of the parts renders them expensive to ship around the world. Due to the nature of these metals, they are susceptible to the corrosive effects of chemicals typically found in such environments.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to use a composite material for the manufacture of a product fixture assembly that will render the product fixture assembly less expensive to transport and handle.

It is another aspect of the present invention to use a composite material for the manufacture of a product fixture assembly, wherein the composite material provides electrically insulated components of the product fixture assembly and thereby eliminate the risk of shock to in-field service personnel handing the product fixture assembly.

It is another aspect of the present invention to use a composite material for the manufacture of a product fixture assembly that reduces the overall cost of the product fixture assembly while permitting the product fixture assembly to be resistant to corrosion, while improving the life of the product and reducing the overall cost.

The aforementioned aspects of the invention and other objectives and advantages can now be achieved as described herein. A method and apparatus thereof for providing a material for use in forming a product fixture assembly is disclosed. One or more flaws of a currently utilized material can be analyzed for use in meeting a particular requirement of a product fixture assembly in order to identify one or more alternate materials for use in meeting the particular requirement of the product fixture assembly. The alternate material(s) are then analyzed with regard to all requirements of the product fixture assembly, in response to identifying the alternate material(s). In response to analyzing the flaw(s) in the currently utilized material and analyzing the alternate material(s), an offering of the alternate material(s) can be developed, wherein such an offering meets the particular requirement of the product fixture assembly and overcomes the flaws(s) associated with the currently utilized material. The alternate material(s) can be then selected in order to develop the product fixture assembly in a manner that meets the particular requirement of the product fixture assembly. A new material may also be developed, which meets the particular requirement of the product fixture assembly, if it is determined that the alternate material(s) do not meet the requirements of the product fixture assembly.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic plan view of an exemplary visible lighting arrangement for an airport runway to which a preferred embodiment of the present invention can be adapted;

FIG. 2 illustrates a perspective view of an approach end of the runway of FIG. 1, showing in more detail some commonly-used types and placements of runway light fixtures;

FIG. 3 illustrates a flow chart of operations depicting logical operational steps of a method of providing a material for use in forming a product fixture assembly, in accordance with a preferred embodiment;

FIG. 4 illustrates a flow chart of operations depicting logical operational steps of a method of providing a material for use in forming a product fixture assembly, in accordance with an alternative embodiment; and

FIG. 5 illustrates a logical flow chart of operations depicting a method 500 of selecting and utilizing particular composite materials for use in forming a product fixture assembly, in accordance with an alternative embodiment.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

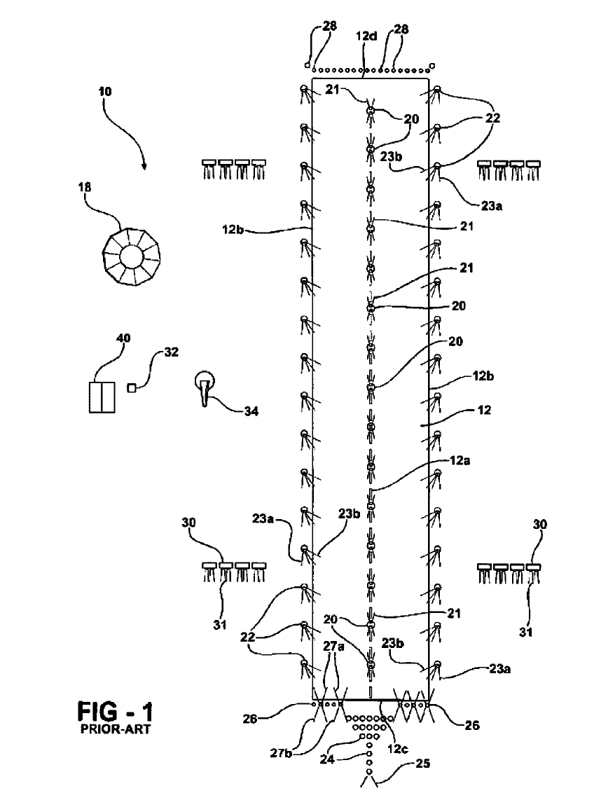

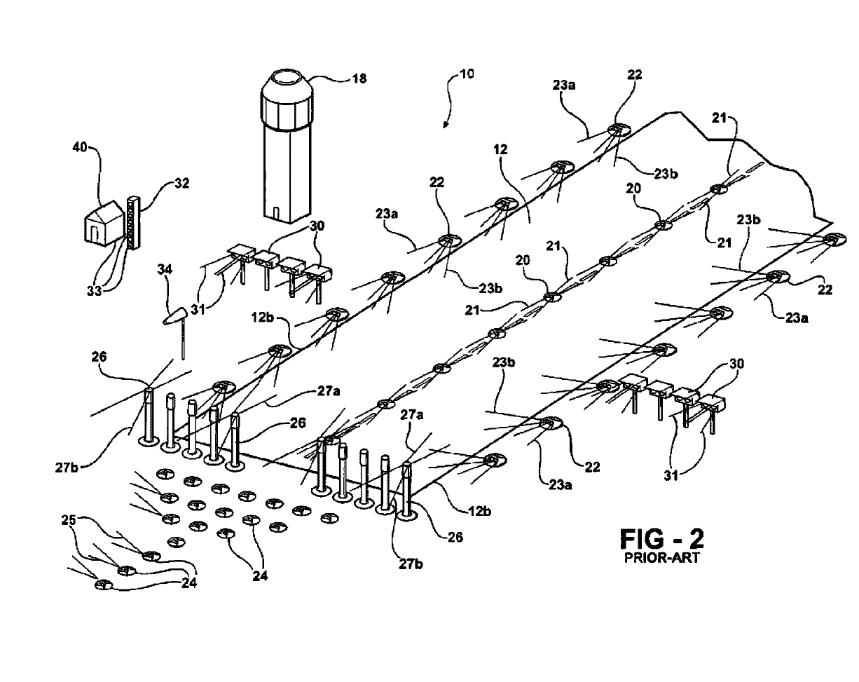

Referring first to FIGS. 1 and 2, a runway installation 10 is schematically illustrated, with a permanent paved runway 12 of known type at a commercial or military airport. The resulting material utilized as depicted herein can be adapted for use with product fixture assemblies utilized in associate with the arrangement depicted in FIGS. 1 and 2. Such runways may or may not have a control tower 18 nearby, depending on the size, type, and activity level of the airport. Runway 12 preferably possesses an essentially permanent array of light fixtures on and around the runway and any associated taxiway and terminal structures. Such light fixtures may be supported by one or more product fixture assemblies. For simplicity only a runway 12 is shown, but it will be apparent to those skilled in the art that taxiways, terminals, and other known complementary structures requiring lighting to guide aircraft can be included in runway installation 10.

Runway 12 is typically provided with several different types of light fixture, set in different arrays for different purposes. In the illustrated example, the runway centerline 12a is marked at intervals with runway centerline lights 20 of known type, embedded flush or nearly so with the paved surface of the runway and emitting light patterns 21 aligned with the centerline in known fashion. Centerline lights 20 can vary in their construction, are available from many commercial sources, and may be unidirectional for single-direction runways or (as illustrated in FIG. 1) bidirectional for runway operation in both directions or to indicate right and wrong landing direction, for example by emitting light of different color in each direction. Such centerline lights 20 generally constitute an airport lighting fixture (e.g. product fixture assembly). As indicated previously, prior art airport lighting fixtures are generally produced from Aluminum or Steel. These are usually heavy, cumbersome parts to handle by maintenance personnel. Additionally, these parts are electrically conductive. In the event of a ground fault condition, a worker can receive a shock while working on the lamp in the field. Due to the nature of metal production methods, the assemblies are expensive to manufacture. The weight of the parts renders them expensive to ship around the world. Due to the nature of these metals, they are susceptible to the corrosive effects of chemicals typically found in such environments. The approach described herein, however, results in the formation of centerline lights 20 and other product fixture assemblies that overcome these problems.

In the example depicted in FIG. 1, the side edges 12b of the runway can be marked along their length in a conventional fashion with runway edge lights 22 of known type, similar to centerline lights 20 but often having two diverging or differently-angled lamps, one throwing a light pattern 23a essentially parallel to or only slightly angled in toward the runway edge, and one throwing a more strongly angled or “toed-in” light pattern 23b toward the runway centerline. Runway edge lights 22 constitute another type of product fixture assembly and can be mounted low or nearly flush to the ground like centerline lights 20, and may be very similar in appearance and function, such that it is known to use the same type of light fixture both for centerline and edge lighting.

Runway edge lights 22, however, often have a deeper mounting base or anchor in the form of a metal cylinder (commonly referred to as a “can”) anchored deeply into the ground or pavement and capable of removably receiving the fixture housing the lamp and lens assemblies. Runway edge lights 22 (e.g., a product fixture assembly) may also be rotatably adjustable on their mounts, to vary the toe-in angle relative to the runway. Note that the term “product fixture assembly” as utilized herein can refer to a structure that supports a product, such as the airport lights described with respect to FIGS. 1-2 or the lights themselves or any number of other products, which may or may not be related to an airport setting. For example, scaffolding used in a construction setting may constitute a type of product fixture assembly.

The approach end 12c of runway 12 is often marked by a geometric pattern of approach lights 24, for example in a triangle or arrowhead pattern similar to that shown in FIG. 1. In the illustrated embodiment of FIG. 1, approach lights are similar to runway edge lights 22 in their structure and their low-to-the-ground or inset mounting, but may for example have only a single unidirectional lamp emitting a light pattern 25 pointing generally in the direction of the approaching aircraft.

The actual threshold 12c of the paved runway 12 is often separately lit, for example by a straight row of vertical post-mounted type threshold lights 26 of known type, often with a multi-directional light pattern to both light the edge of the pavement (27a) and to be seen by an approaching aircraft (27b) to clearly mark the transition from approach lights 24 to the actual pavement threshold.

The end 12d of the runway, where the pavement runs out, will typically be marked with its own array of runway end indicator lights 28, which again may be post-mounted lights similar to threshold lights 26.

An aircraft's angle of approach may also be assisted with precision approach path indicator or “PAPI” lights 30, usually raised, multi-lamp, sometimes multi-color fixtures with the respective angles of the lamps themselves set such that an over/under or on/off color or light pattern 31 discernible to the approaching aircraft can be gauged for a go or no-go landing decision (for example, red-over-white OK to land, white-over-red go around again).

FIGS. 1 and 2 also show a windspeed indicator bar 32 of known type, with a vertical array of lamps 33 in mph or kph increments, for example each lit bulb denoting a 10-mph increase in windspeed. A wind-sock or -cone 34 indicates wind direction in known manner, and may be lit at night by a downwardly-angled light or lights set at the top of its pole, again in known manner.

It will be apparent to those skilled in the art of runway lighting that many variations on runway lighting patterns exist, that different types of fixture are often mixed and matched in custom arrays, that fixtures intended for one purpose (centerline lighting) may find use at a particular runway installation for a different purpose, and that other known types of runway light fixtures that have not been specifically named above are similar or equivalent to those shown herein for purpose of illustration.

Still referring to FIGS. 1 and 2, the runway light fixtures (i.e., product fixture assemblies) are typically powered through underground electrical conduit of known type (not shown), and often controlled at a centralized control panel or station such as a “vault” or building 40 by manual or automated switching and other controls. An operator 50 or pre-programmed control at the vault can turn individual lights and/or arrays on and off; change lighting patterns and direction; and may even be capable of selectively enabling different lamps in one or more fixtures. Such power supply and control structures and methods are well known to those skilled in the art. Control may also be from the tower 18 or even remotely, as from a radio signal transmitted from an approaching aircraft 60 in known manner to enable an automated activation of the runway lights at an unmanned airport.

It can be appreciated the configuration depicted in FIGS. 1-2 represents merely one example of product fixtures assemblies that can be implemented according to the methodology described herein and that other structures for other uses (e.g., portable scaffolding, non-airport applications, etc) may be utilized in accordance with varying embodiments. For example, the embodiments described herein may be adapted for use for supporting product fixture assemblies for use in an arrangement such as that disclosed in U.S. Pat. No. 7,023,361, entitled “Covert Runway Lighting Apparatus and Method” which issued to Wallace et al on Apr. 4, 2006, and is incorporated herein by reference.

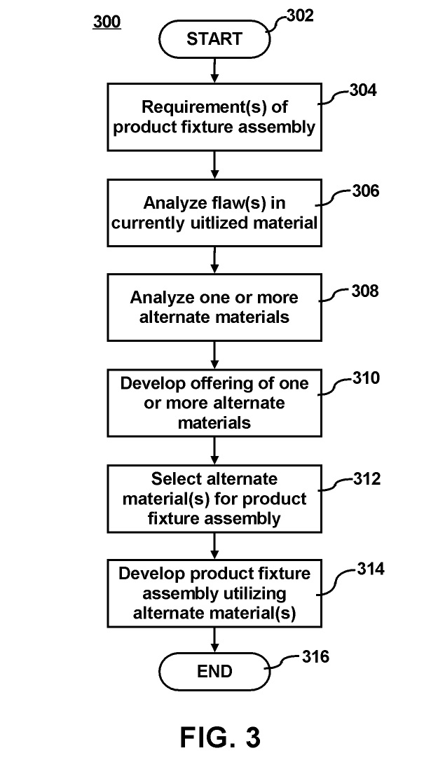

FIG. 3 illustrates a flow chart of operations depicting logical operational steps of a method of providing a material for use in forming a product fixture assembly, in accordance with a preferred embodiment. As indicated at block 302, the process is initiated. Thereafter, as depicted at block 304, an operation can be performed to determine particular requirements of a product fixture assembly. Such requirements may be, for example, physical and/or environmental requirements related to the product fixture assembly itself and materials utilized to form the product fixture assembly. Next, as depicted at block 306, an operation can be processed for analyzing one or more flaws in a currently utilized material for use in meeting the particular requirement(s) of the product fixture assembly and in order to identify one or more alternate materials for use in meeting the particular requirement(s) of the product fixture assembly.

Thereafter, as described at block 308, the alternate material(s) can be analyzed with regard to all requirements of the product fixture assembly, in response to identifying the alternate material(s). Note that such alternate materials can be, for example, composite materials. Next, as indicated at block 310, a step can be implemented in which in response to analyzing the flaw(s) in the currently utilized material and analyzing the alternate material(s), an offering of the alternate material can be developed, wherein such an offering meets the particular requirement of the product fixture assembly and overcomes the flaw(s) associated with the currently utilized material. Thereafter, as depicted at block 312, the alternate material(s) can be selected in order to develop the product fixture assembly as depicted at block 314, in a manner that meets the particular requirement of the product fixture assembly. The process then terminates as indicated at block 316.

Note that producing a product fixture assembly using an alternate material, such as, for example, a composite material, can reduce the weight, thereby making the resulting product fixture assembly less expensive to ship and easier to handle by maintenance workers. Producing these parts out of a composite material can also create an electrically insulated part that will eliminate the risk of shock to the in-field service worker. The nature of the material lends itself to less expensive production methods, reducing the overall cost of the product. Because these materials are inherently resistant to corrosion, additional treatments to prevent damage from chemical attachment can be eliminated, thereby improving the life of the product fixture assembly while reducing the overall cost.

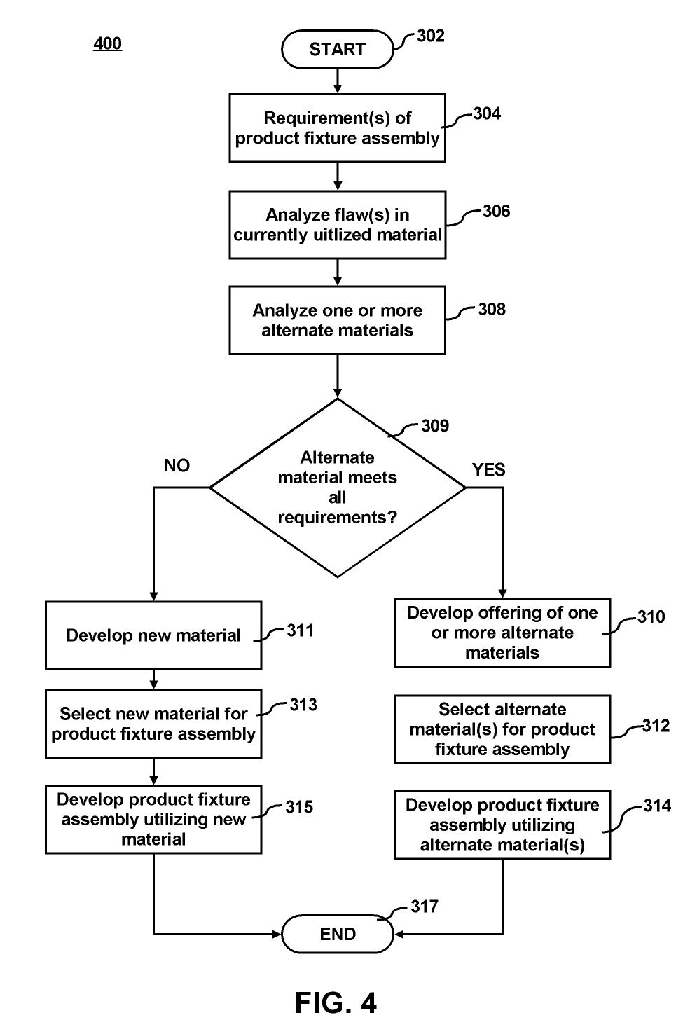

FIG. 4 illustrates a flow chart of operations depicting logical operational steps of a method 400 of providing a material for use in forming a product fixture assembly, in accordance with an alternative embodiment. Note that in FIGS. 3-4, identical or similar parts or elements are generally indicated by identical reference numerals. Thus, the method 400 disclosed in FIG. 4 is similar to method 300 illustrated in FIG. 3, the difference being that method 400 includes additional operational steps, as depicted at blocks 309, 311, 313, and 315. The operational steps illustrated at block 309, 311, 313, and 315 are provided to take into account the possibility that a new developing a new material may developed, which meets the particular requirement of the product fixture assembly, if it is determined that the analyzed alternate material(s) will not meet all requirements of the product fixture assembly.

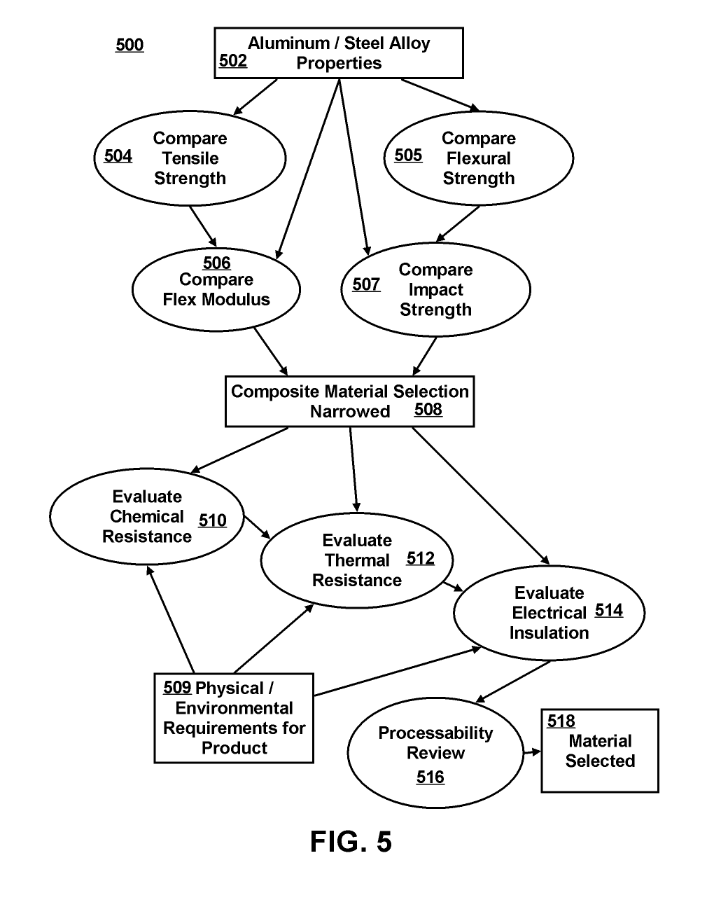

FIG. 5 illustrates a logical flow chart of operations depicting a method 500 of selecting and utilizing particular composite materials for use in forming a product fixture assembly, in accordance with an alternative embodiment. As depicted at block 502, one or more materials (e.g., aluminum/steel alloy) can be provided having particular properties. The properties of these materials can be then compared against the properties of one or more composite materials (e.g., fiberglass). Various operations can be implemented to analyze these composite materials for use in forming a product fixture assembly, such as, for example, the portable product fixture assemblies depicted in FIGS. 1-2 by comparing the properties of such composite material(s) to the properties of the materials depicted at block 502, one or more composite materials can be selected for use in forming the product fixture assembly.

For example, as indicated respectively at blocks 504, 505, 506, and 507, the tensile strength, the flexural strength, the flex modulus, and the impact strength of the composite material(s) can be compared in order thereby narrow the selection of the composite material(s), as depicted at block 508. Thereafter, several evaluation operations may be implemented for evaluating one or more resistance properties (e.g., chemical resistance and thermal resistance) and the electrical insulation associated with the selected narrowed composite material(s) n order to ensure that the product fixture assembly possesses an optimal weight, sufficient electrical insulation, and corrosion resistance for transportation, storage, maintenance and usage thereof. In the example depicted in FIG. 5, the chemical resistance can be evaluated, as depicted at block 510 by itself or in association with an evaluation of the thermal resistance as indicated at block 512. An evaluation of the electrical insulation is indicated at block 514. Such an evaluation of properties can also take into consideration the physical/environmental requirements for the actual product associated with the product fixture assembly, as indicated at block 509. An operation can then be performed in which the processability of the evaluated composite material(s) is reviewed. Finally, as depicted at block 518, one or more composite materials can be selected for use in forming the product fixture assembly, in response to comparing and evaluating the composite materials.

One of the innovative advantages of the approach described herein involves the application of composite materials in a product classification where metal is traditionally used. The selection process also allows for the possibility of developing a new material by identifying the flaws in the materials currently available and working with a material provider to develop an offering that meets the product need. Once the material is selected, the design process can develop the product into a shape that meets the product need.

Note that there are a number of different types of composite materials that can be utilized in accordance with the embodiments disclosed herein. Examples of such composite materials include fiberglass, PAN-based carbon and Aramid. Fiberglass, for example, includes Type E and Type S fiber product codes, whereas PAN-based carbon includes high strength and high modulus fiber product codes. Aramid, for example, includes Kevlar 49 and Kevlar 29. Resin types for use in forming such fiber types include epoxy, phenolic, polyamide, polyester, and silicone. These materials describe basic families that can be considered for use in replacing, for example, aluminum and steel. Varying the fiber type and resin type can produce gross changes in the material properties. Also, varying the product code results in minor effects that allow for fine tuning of the materiel properties. Additionally, varying the length of the fiber products a significant effect on the final material properties and allows for adjusting the properties the particular application. Table 1 below outlines examples of such non-conductive and composite materials:

TABLE 1
Examples of Non-conductive, Composite Materials

| Fiber Type | Fiber Product Code | Resin Type |
|---|---|---|
| Fiberglass | Type E | Epoxy, Phenolic, Polyamide, |
| | Type S-2 | Polyester, Silicone |
| PAN - Based | High Strength | Epoxy, Phenolic, Polyamide, |
| Carbon | High Modulus | Polyester, Silicone |
| Aramid | Kevlar 49 | Epoxy, Phenolic, Polyamide, |
| | Kevlar 29 | Polyester, Silicone |

Note that an example of a product fixture assembly which may be produced using an alternate material (e.g., composite material) and the approach described herein is the “Runway Centre Line Light Fitting” such as that produced by Honeywell International Inc. An example of such a product fixture assembly is disclosed in the document “BOF8T-RCEL 8 inch Runway Centre Line Light Fitting” dated September 2003 and printed in Germany, which is incorporated herein by reference. It can be appreciated, however, that this particular lighting structure does not constitute a limiting feature of the embodiments disclosed herein, but is referred to for general exemplary and edification purposes only.

It can be appreciated that the methodology described herein offers a number of advantages. For example, producing product fixture assemblies using a composite material will reduce the weight, thereby making it less expensive to ship and easier to handle by maintenance workers. Producing these parts out of a composite material will also create an electrically insulated part that will eliminate the risk of shock to the in-field service worker. The nature of such composite materials also lends itself to less expensive production methods, reducing the overall cost of the product. Because these materials are inherently resistant to corrosion, additional treatments to prevent damage from chemical attach can be eliminated, improving the life of the product while reducing the overall cost.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of providing a material for use in forming a product fixture assembly, comprising:
analyzing at least one flaw in a currently utilized material for use in meeting a particular requirement of a product fixture assembly in order to identify at least one alternate material for use in meeting said particular requirement of said product fixture assembly;
analyzing said at least one alternate material with regard to all requirements of said product fixture assembly, in response to identifying said at least one alternate material;
developing, in response to analyzing said at least one flaw in said currently utilized material and analyzing said at least one alternate material, an offering of said at least one alternate material, wherein said offering meets said particular requirement of said product fixture assembly and overcomes said at least one flaw associated with said currently utilized material; and
thereafter selecting said at least one alternate material in order to develop said product fixture assembly in a manner that meets said particular requirement of said product fixture assembly.

2. The method of claim 1 further comprising developing a new material that meets said particular requirement of said product fixture assembly, if it is determined that said at least one alternate material will not meet said all requirements of said product fixture assembly.

3. The method of claim 1 wherein said at least one alternate material comprises a composite material.

4. The method of claim 1 wherein said particular requirement of said product fixture assembly comprises a shape of said product fixture assembly.

5. The method of claim 1 wherein said particular requirement of said product fixture assembly comprises a tensile strength associated with said product fixture assembly.

6. The method of claim 1 wherein said particular requirement of said product fixture assembly comprises a preferred flex modulus associated with said product fixture assembly.

7. The method of claim 1 wherein said particular requirement of said product fixture assembly comprises an impact strength associated with said product fixture assembly.

8. The method of claim 1 said particular requirement of said product fixture assembly comprises a physical requirement and an environmental requirement associated with said product fixture assembly.

9. A method of providing a material for use in forming a product fixture assembly, comprising:
analyzing at least one flaw in a currently utilized material for use in meeting a particular requirement of a product fixture assembly in order to identify at least one alternate material for use in meeting said particular requirement of said product fixture assembly;
analyzing said at least one alternate material with regard to all requirements of said product fixture assembly, in response to identifying said at least one alternate material;
developing, in response to analyzing said at least one flaw in said currently utilized material and analyzing said at least one alternate material, an offering of said at least one alternate material, wherein said offering meets said particular requirement of said product fixture assembly and overcomes said at least one flaw associated with said currently utilized material;
thereafter selecting said at least one alternate material in order to develop said product fixture assembly in a manner that meets said particular requirement of said product fixture assembly; and
thereafter developing a new material that meets said particular requirement of said product fixture assembly, if it is determined that said at least one alternate material will not meet said all requirements of said product fixture assembly.

10. The method of claim 9 wherein said at least one alternate material comprises a composite material.

11. The method of claim 9 wherein said particular requirement of said product fixture assembly comprises a shape of said product fixture assembly.

12. The method of claim 9 wherein said particular requirement of said product fixture assembly comprises a tensile strength associated with said product fixture assembly.

13. The method of claim 9 wherein said particular requirement of said product fixture assembly comprises a preferred flex modulus associated with said product fixture assembly.

14. The method of claim 9 wherein said particular requirement of said product fixture assembly comprises an impact strength associated with said product fixture assembly.

15. The method of claim 9 said particular requirement of said product fixture assembly comprises a physical requirement and an environmental requirement associated with said product fixture assembly.

16. An apparatus for use in forming a product fixture assembly, wherein said apparatus comprises:
a currently utilized material that is analyzed for use in meeting a particular requirement of a product fixture assembly in order to identify at least one alternate material for use in meeting said particular requirement of said product fixture assembly;
at least one alternate material analyzed with regard to all requirements of said product fixture assembly, in response to identifying said at least one alternate material; and
an offering of said at least one alternate material, said offering developed in response to analyzing said at least one flaw in said currently utilized material and analyzing said at least one alternate material, wherein said offering meets said particular requirement of said product fixture assembly and overcomes said at least one flaw associated with said currently utilized material, said at least one alternate material selected in order to develop said product fixture assembly in a manner that meets said particular requirement of said product fixture assembly.

17. The apparatus of claim 16 further comprising a new material that meets said particular requirement of said product fixture assembly, wherein said new material is produced if it is determined that said at least one alternate material will not meet said all requirements of said product fixture assembly.

18. The apparatus of claim 16 wherein said at least one alternate material comprises a composite material.

19. The apparatus of claim 16 wherein said particular requirement of said product fixture assembly comprises a shape of said product fixture assembly.

20. The apparatus of claim 16 said particular requirement of said product fixture assembly comprises a physical requirement and an environmental requirement associated with said product fixture assembly.
